(19) United States
(12) Patent Application Publication
(10) Pub. No.: US 2024/0197028 A1
(43) Pub. Date: Jun. 20, 2024

(54) BATTERY CHARGING SYSTEM FOR A SHOE ACCESSORY, SHOE COMPRISING A SHOE ACCESSORY, AND BASE FOR CHARGING SUCH A SHOE

(71) Applicant: Zhor Tech, Nancy (FR)

(72) Inventors: Karim OUMNIA, Nancy (FR); Franck LEMKE, Nancy (FR); François COULONGEAT, Nancy (FR)

(21) Appl. No.: 18/554,496

(22) PCT Filed: Apr. 7, 2022
(86) PCT No.: PCT/EP2022/059215

§ 371 Date: Oct. 9, 2023

(30) Foreign Application Priority Data
Apr. 7, 2021 (FR) FR2103565

(51) Int. Cl. A43B 5/14; A43B 3/34; A63B 21/00; A63B 22/06; H02J 7/00

(52) U.S. Cl. CPC A43B 5/14; A43B 3/34; A63B 21/4034; A63B 22/0605; H02J 7/0045

(57) ABSTRACT

The invention relates to a battery charging system (1) comprising: a shoe accessory (100) adapted to receive an electronic device (200) comprising a rechargeable battery (250); a charging base (300) configured to generate a charging current, and a charging surface (310) for receiving the shoe accessory (100), the charging base (300) being configured to send the charging current to the rechargeable battery (250) via the charging surface (310); conductive attachment means (140) for attaching the shoe accessory (100) to a shoe (10-1, 10-2). According to the invention, when the shoe accessory is attached to a shoe (10-1, 10-2), a first end of the conductive attachment means is in electrical contact with the rechargeable battery (250), and a second end of the conductive attachment means is in electrical contact with the charging surface (310).

### TECHNICAL FIELD

The invention focuses on the field of shoe accessories, and more particularly on the charging of shoe accessory batteries including an electronic device. More particularly, the invention relates to a system for charging a battery of an electronic device integrated or integrable into a shoe accessory.

The invention further relates to a shoe comprising a shoe accessory including an electronic device provided with a rechargeable battery. The invention also relates to a charging base intended to receive a shoe accessory.

### PRIOR ART

The development of the Internet of Things now affects all areas of our society.

Indeed, the connected objects are omnipresent in everyday life and are thus present in the clothes we wear. More particularly, the shoes represent the items that have been the subject of the most advanced developments over the years. The connected objects initially integrated into the shoes were first aimed at analyzing human gait.

These systems for analyzing the gait include for example the use of shoes equipped with pressure sensors or inertial sensors positioned in the sole, on the shoe or at the ankle. Particularly, several teams have focused on the use and processing of the inertial sensor data for the analysis of human movement.

There is thus a whole range of connected objects that can be integrated into or removed from a shoe according to the user's needs. Although in some cases, such connected objects can be easily separated from the shoe, in particular to download data generated by integrated sensors or to charge the battery of the connected object depending on the level of integration of the connected object, data recovery as well as battery charging can cause problems.

In this context, a solution has been described in patent application No. WO2018208891 and proposes the integration into the outsole of the shoe of a connection technology for easily withdrawing the electronic device in order to charge it or recover the data generated by the latter. A flexible connector comprising flexible wings made of an elastomeric material thus allows the connector to deform and facilitate the coupling and decoupling of the electronic device.

However, some shoes require the addition of complementary accessories, in particular in the context of the practice of some sports such as board sports practiced on snow or in water, but also sports practiced on dry land such as cycling.

Such complementary accessories can be removable, but often require dismounting all or part of the shoe. The integration of an electronic device into this type of shoe is made tedious on the one hand by the often reduced size that must be made by the electronic device and on the other hand by the possibility of accessing it in order to charge it. Indeed, the main function of this type of electronic devices is to measure the user's activity and for this, the electronic devices must be positioned in very specific places in the shoe. Therefore, it is important to be able to charge them without having to dismount the entire shoe to access the battery of the electronic device.

For this, a solution was described in patent application No. US2020016459 and proposes the use of a shoe accessory, in this case a cleat, comprising sensors and positioned in the front half (in the toe area) of the outsole of the shoe. A battery housing is disposed in the rear half (at the heel) of the outsole. The battery housing is arranged to accommodate a rechargeable battery electrically connected to the shoe accessory comprising the sensors, via flexible wires or cables introduced into a duct formed inside the outsole up to the shoe accessory including the electronic device, in this case the sensors. Thus, the user can access the rechargeable battery independently of the electronic device via a removable part of the outsole of the shoe positioned at the heel. Furthermore, it is described that the shoe can include a solar cell positioned opposite the outsole for powering the shoe accessory, or a kinetic energy converter for converting the cyclical movement of the shoe into an electric current. The power supply thus comprises a movable weight which, when moved relative to a coil, generates an electric current.

These solutions made it possible to facilitate the charging of an electronic device integrated into a shoe or shoe accessory by facilitating access to the battery of said electronic device or by coupling it to external charging systems when using the shoe. However, the user remains under the obligation of dismounting part of the shoe or shoe accessory to access the battery of the electronic device in order to charge it, or remains dependent on the use of binding external systems to ensure the charging of the battery. Thus, there is a need for a solution allowing the charging of a battery of an electronic device integrated into a shoe or shoe accessory making it possible to avoid dismounting/remounting of the shoe accessory or part of the shoe when charging the battery.

### Technical Problem

The invention aims to overcome the drawbacks of the prior art. Particularly, the invention aims to provide a system for charging an electronic device present in a shoe accessory of a shoe allowing the user to recharge the electronic device present in the shoe accessory, without dismounting the shoe or the shoe accessory, while limiting the space required to integrate the electronic device into the shoe accessory.

### SUMMARY OF THE INVENTION

To this end, the invention relates to a battery charging system comprising:
a shoe accessory adapted to receive an electronic device comprising a rechargeable battery,
a charging base comprising a power supply configured to generate a charging current, and a charging surface intended to receive the shoe accessory, the charging base being configured to send the charging current to the rechargeable battery via the charging surface, and
conductive fixing means, intended to fix the shoe accessory on a shoe,
wherein, when the shoe accessory is fixed to a shoe,
   a first end of the conductive fixing means comes into electrical contact with the rechargeable battery, and
   a second end of the conductive fixing means comes into electrical contact with the charging surface.

According to other optional characteristics of the system, the latter can include one or several of the following characteristics, alone or in combination:
the electronic device comprises a connector consisting of an electrical cable intended to be crimped or welded to the shoe accessory so that the first end of the conductive fixing means comes into electrical contact with the rechargeable battery.
the shoe accessory includes a housing and the electronic device comprises a spring connector, said housing being adapted to receive and hold the electronic device so that the first end of the conductive fixing means comes into electrical contact with the rechargeable battery via the spring connector.
the shoe accessory comprises an internal face adapted to receive a conductive means, said conductive means being arranged so that the first end of the conductive fixing means comes into electrical contact with the rechargeable battery via the conductive means.
the conductive means is a lug washer.
the shoe accessory comprises at least one hooking system arranged to fit into the charging base and to ensure the electrical contact between the second end of the conductive fixing means and the charging surface.

The invention also relates to a shoe comprising a shoe accessory adapted to receive an electronic device comprising a rechargeable battery, the shoe accessory being fixed to the shoe via conductive fixing means including a first end and a second end, the shoe accessory being further adapted to be received by a charging surface of a charging base, so that when said shoe accessory is received by the charging surface:
the first end of the conductive fixing means comes into electrical contact with the rechargeable battery, and
the second end of the conductive fixing means comes into electrical contact with the charging surface.

According to other optional characteristics of the shoe, the latter can include one or several of the following characteristics, alone or in combination:
an outsole which comprises at least one accommodation means and in which the shoe accessory comprises at least one opening, the conductive fixing means being adapted to cooperate with the accommodation means through the opening so as to form a mechanical connection between the shoe accessory and the outsole of the shoe.
the electronic device comprises a connector consisting of an electrical cable intended to be crimped or welded to the shoe accessory so that the first end of the conductive fixing means comes into electrical contact with the rechargeable battery.
the shoe accessory includes a housing and the electronic device comprises a spring connector, said housing being adapted to receive and hold the electronic device such that the first end of the conductive fixing means comes into electrical contact with the rechargeable battery via the spring connector.
the shoe accessory comprises at least one hooking system arranged to fit into the charging base and to ensure the electrical contact between the second end of the conductive fixing means and the charging surface.

The invention further relates to a charging base comprising a power supply configured to generate a charging current and a charging surface intended to receive a shoe accessory of a shoe according to the invention, in which when the shoe accessory of the shoe is received by the charging surface, the first end of the conductive fixing means comes into electrical contact with the rechargeable battery, and the second end of the conductive fixing means comes into electrical contact with the charging surface, the charging base being further configured to send the charging current to the rechargeable battery via the charging surface.

According to other optional characteristics of the charging base, the latter can include one or several of the following characteristics, alone or in combination:
it is formed in a clipless pedal of an electric bike and the power supply is a battery integrated into said electric bike, said battery being electrically coupled to the clipless pedal.

### BRIEF DESCRIPTION OF THE DRAWINGS

Other advantages and characteristics of the invention will appear upon reading the following description given by way of illustrative and non-limiting example, with reference to the appended Figures.

FIG. 1 is a schematic representation of a battery charging system according to the invention.

FIG. 2 is a front view of a shoe accessory, more particularly a cleat, according to one embodiment of the invention.

FIG. 3 is a diagram of an electronic device adapted to be integrated into a shoe accessory.

Aspects of the present invention are described with reference to flowcharts and/or functional diagrams of methods, apparatuses (systems) according to embodiments of the invention.

In the figures, flowcharts and functional diagrams illustrate the architecture, functionality and operation of possible implementations of systems, methods according to various embodiments of the present invention. In this regard, each block in the flowcharts or block diagrams may represent a system, a device, a module, which comprises one or several executable instructions to implement the specified logic function(s). In some implementations, the functions associated with the blocks may appear in a different order than indicated in the figures. For example, two blocks shown successively can in fact be executed substantially simultaneously, or the blocks may sometimes be executed in the reverse order, depending on the functionality involved. Each block of the flow diagrams and/or flowchart, and combinations of blocks in the flow diagrams and/or flowchart, can be implemented by special hardware systems that execute the specified functions or acts or perform combinations of special hardware and computer instructions.

### DESCRIPTION OF THE EMBODIMENTS

The expression “shoe accessory” corresponds to any element or object intended to be fixed to or integrated into a shoe. The shoe accessory can thus be integrated into or fixed to an outsole or insole of a shoe and can in particular correspond to a crampon, a cleat or an insole.

By “charging current” it is meant an electric current generated by an apparatus making it possible to recharge one or several electric accumulators.

A “clipless pedal” corresponds to a particular type of bike pedal allowing the fixing of the user's foot to the bicycle pedal via a cleat fixed under the shoe worn by the user. A reversible fixing system inside the pedal makes it possible to engage and disengage the cleat and therefore release the foot when the user wants to get off the bike.

By “sole” it is meant an object making it possible to separate the user's foot from the ground. A shoe can include an insole layer in direct contact with the user's foot and an outsole layer in direct contact with the ground or more generally the external environment. A shoe can also include a removable insole.

In the remainder of the description, the “gait” within the meaning of the invention corresponds to the posture, movements, locomotion, and balance of the user. The balance corresponds in particular to postural balance related to the stability of the body and more particularly to the stability of the center of gravity of a user. However, it can integrate both static balance and dynamic balance.

The “quantification of the gait” corresponds, within the meaning of the invention, to the attribution of one or several values, for example a score, a classification or a note to a trajectory or a displacement of a foot of a user. This quantification of the gait makes it possible to obtain one or several values of biomechanical parameters representative of the gait and can be carried out on the basis of numerous linear or non-linear scales of different sizes (e.g., 1, 5, 10, 100).

The term “conductive” or “electrically conductive” refers to any type of material, known to those skilled in the art, making it possible to conduct an electric current such as the charging current.

By “biomechanical parameter” and more particularly by “parameter calculated from movement data”, it is meant within the meaning of the invention the result of a transformation of the measured trajectory of a user's foot into one or several values.

By “removable” it is meant the ability to be detached, removed or dismounted easily without having to destroy the fixing means either because there is no fixing means or because the fixing means are easily and quickly dismountable (e.g. notch, screw, tab, lug, clips). For example, by “removable”, it should be understood that the object is not fixed by welding or by another means not intended to allow detaching the object.

By “plastic composite”, it is meant within the meaning of the invention, a multi-component material comprising at least two immiscible components in which at least one component is a (thermoplastic or thermosetting) polymer and the other component can be a reinforcement such as fibrous reinforcement.

By “fibrous reinforcement” or “fibrous substrate”, it is meant within the meaning of the invention several fibers, unidirectional rovings or a continuous filament mast, fabrics, felts or non-wovens which can be in the form of strips, sheets, braids, strands or pieces.

By “polymer” it is meant either a copolymer or a homopolymer. By “copolymer” it is meant a polymer grouping together several different monomer units and by “homopolymer” it is meant a polymer grouping together identical monomer units.

By “thermoplastic polymer”, it is meant within the meaning of the invention, a polymer which is generally solid at room temperature, which can be crystalline, semi-crystalline or amorphous, and which softens upon an increase in temperature, particularly after passage of its glass transition temperature (Tg) and flows at a higher temperature. Examples of thermoplastics are for example: low-density polyethylene (LDPE), polyethylene terephthalate (PET) or polyvinyl chloride (PVC).

By “Thermosetting polymer” it is meant a plastic material which is transformed irreversibly by polymerization into an insoluble polymer network.

In the description, the same references are used to designate the same elements.

In order to allow the measurement of parameters associated with the gait of an individual, existing electronic devices, configured to perform such measurements, are generally integrated directly into the insole or outsole of the shoe. Indeed, to measure the parameters associated with the gait of the individual, the electronic device must be placed as close as possible to the foot of the individual. Very often, the electronic device will be placed in a shoe accessory, and not directly on the foot of the user, so as not to interfere with the gait of the user. Depending on the user's practice, he will have to wear a very specific shoe and the electronic device can be integrated into different types of shoe accessories in order to allow the measurement of the gait parameters of the user without disturbing him. Currently, electronic devices are systematically, partially or totally, integrated into the insole or outsole of the shoe. This has the advantage of facilitating access to the electronic device in particular to allow its charging, but requires the dismounting and remounting of the shoe or shoe accessory, or involves substantial modifications to the structure of the shoe which could alter the performance of the shoe or of the user.

Faced with these shortcomings, the inventors have developed a battery charging system making it possible to eliminate the need to dismount/remount the shoe or shoe accessory in which an electronic device, including such a battery, is integrated. The user can thus directly place the shoe on which the shoe accessory integrating the electronic device and therefore the battery is fixed, on a charging base without requiring complementary manipulations to remove the electronic device. Furthermore, such a charging system makes it possible to avoid any structural modification of the shoe for the integration of the electronic device.

Thus, according to a first aspect, the invention relates to a battery charging system 1.

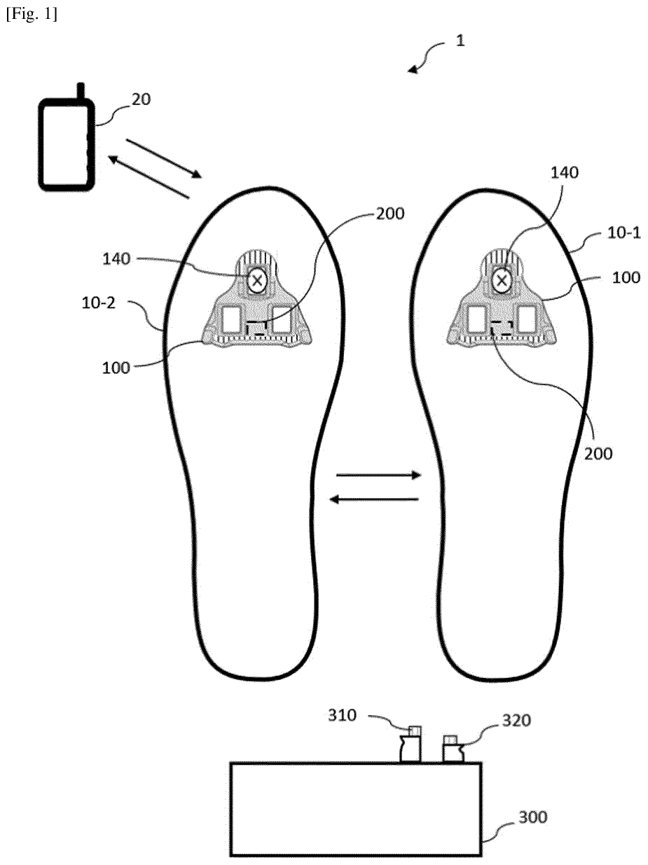

Particularly, and as illustrated in [FIG. 1], such a battery charging system 1 includes a shoe accessory 100, an electronic device 200 comprising a rechargeable battery 2, a charging base 300 intended to receive the shoe accessory, conductive fixing means 140 comprising a first and a second end.

The shoe accessory 100 is particularly adapted to receive an electronic device 200. For this, the shoe accessory 100 can comprise a cavity or a recess whose structure or shape is arranged to accommodate the electronic device 200. Indeed, such a shoe accessory is generally necessary for the practice of a particular sports activity, the shoe accessory 100 is stressed by the user during the practice of the sports activity. Thus, the electronic device 200 used to measure parameters related to the user's gait should be completely integrated into the shoe accessory 100 in order, on the one hand, to more faithfully measure the user's gait and on the other hand to eliminate the need to adapt the shoe. Indeed, it is very often necessary for the shoe and/or the shoe accessory 100 to have specific structural characteristics in order to allow the integration of the elements of the electronic device 200.

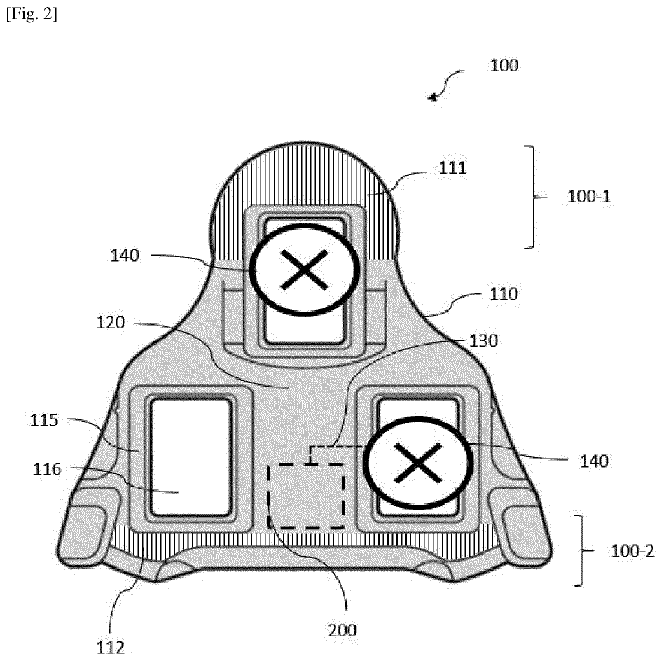

In one particular embodiment of a battery charging system 1 according to the invention, the shoe accessory 100 can take the form of a shoe cleat as described in relation to [FIG. 2]. In this embodiment, the external face of the shoe accessory 100 or of the cleat 100 is presented. The external face of the cleat 100 corresponds to the face intended to come into contact with the charging base 300, so that said external face does not come into direct contact with the shoe.

The cleat 100 comprises a cleat body 110 and can include at least one hooking system arranged to fit into the charging base and allow a removable mechanical connection with said charging base 300. Advantageously, the hooking system can correspond to at least one wedge secured to the cleat body 110 or connected via a reversible wedge attachment. Thus, in one example, the cleat body 110 can comprise two wedges 111, 112 respectively positioned on opposite parts 100-1, 100-2 of the cleat body 110.

In order to facilitate the cooperation between the charging base 300 and the cleat 100, the two wedges 111, 112 can be positioned protruding relative to the cleat body 110 thus allowing the formation of a recess 120 between the two wedges 111, 112. Furthermore, the charging base 300 can comprise at least one pad 320 surmounted by the charging surface 310, the pad 320 being adapted to match the shape of the wedge 111, 112 of the cleat body 110.

Furthermore, in order to facilitate the positioning of the shoe accessory 100, each pad 320 can comprise a magnet or an electromagnet.

In order to accommodate and ensure the holding of the electronic device 200, the cleat 100 or more generally the shoe accessory 100 can include a housing (not represented in the figures). Advantageously, the housing is arranged in the vicinity of a wedge 111, 112 and is accessible at the level of the internal face of the shoe accessory 100. The housing can for example have dimensions such that the electronic device 200 can be maintained in said housing via an embedded-type connection.

As mentioned previously, the battery charging system 1 comprises an electronic device 200.

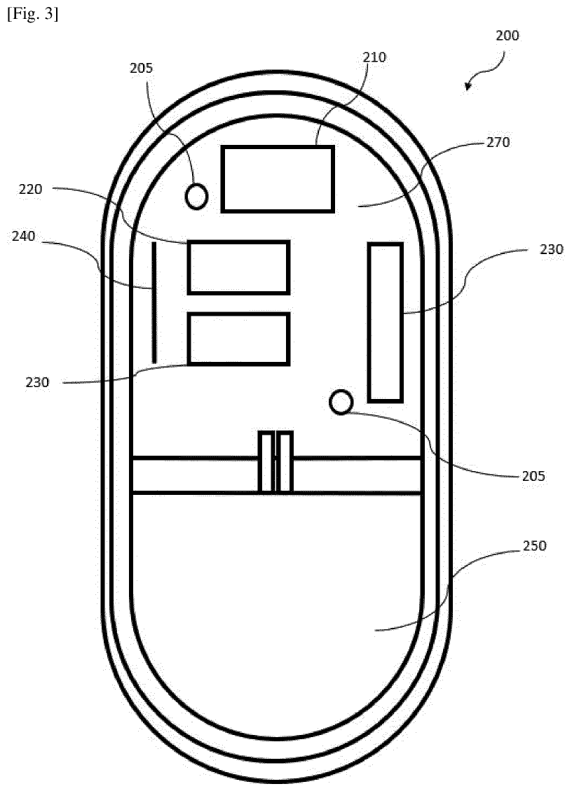

An example of electronic device 200 is detailed in [FIG. 3]. As it weighs only a few grams and has a reduced dimension, in particular with a thickness of less than 5 mm, the electronic device 200 can be housed in a space-saving manner in any shoe accessory 100 without requiring complementary structural modifications. This low volume limits the impact on the user comfort and has the advantage of optimizing production costs by making the integration of this technology into the shoe accessory 100 during the industrial process less expensive and simpler.

The choice of the material of the electronic device 200 is made so as to ensure its solidity as well as the possibility of inserting it into a shoe accessory 100. Indeed, it should be possible to manufacture a product that can, on the one hand, withstand the weight of a person and, on the other hand, be easily inserted into a shoe accessory 100 whether it is an insole, an outsole or a shoe cleat. Advantageously, each electronic device 200 includes an external enclosure, said external enclosure essentially consisting of a plastic composite type material selected from: a thermoplastic composite material or a thermosetting composite material. Preferably, the material used is a thermoplastic-based material such as polycarbonate and can comprise nylon or fiberglass. Indeed, polycarbonate has the advantage of being able to be thermoformed, mechanically resistant and flame retardant, which is advantageous during ultrasonic welding detailed below.

The choice of a polymer material, for example a plastic composite, makes it possible to combine lightness, signal transmission efficiency and, above all, solidity. Advantageously, the enclosure is rounded, in other words, it does not have an angle less than 95°. This shape of enclosure improves the comfort of the user.

Thus, each electronic device 200 is preferably light and weighs for example less than 20 grams, less than 10 grams, preferably less than 8 grams and more preferably less than 6 grams. Furthermore, it may have a thickness of less than 5 mm, preferably less than 4 mm and more preferably less than 3 mm. This allows it to easily integrate into a shoe/sole without altering the user's comfort in his shoe.

Preferably, the external enclosure of the electronic device 200 includes an upper part and a lower part (not represented in the figures) which are welded. Such welding, for example ultrasonic welding, makes it possible to increase the water resistance of the electronic device 200. Alternatively, the upper part and the lower part can be separated by a polymer seal and held by removable fixing means or pads 205. Thus, each electronic device can include an external enclosure formed in two parts and a seal positioned between two parts of the external enclosure.

Preferably of rounded shape to increase its mechanical resistance, it must be assembled in such a way as to maintain perfect sealing and make the interior containing the electronic card and the energy source protected from humidity and dust.

By way of non-limiting example, an electronic device 200 can comprise one or several sensors 210, a data processing module 220, a communications module 230, a data memory 240 and an energy source.

Advantageously, the sensor(s) 210 can consist of an inertial platform configured to generate a set of data on the gait of a user of the shoe accessory 100. During the activity of the user, the inertial platform 210 acquires signals representative of a movement parameter (acceleration and/or speed, for example angular speed) of the foot along the axes X, Y, Z. Furthermore, these data can then be processed to generate at least one acceleration signal. The inertial platform is for example made up of at least an accelerometer and a gyroscope. Preferably, it includes several accelerometers and gyroscopes.

The electronic device 200 can also include one or several magnetometers so as to acquire three additional raw signals corresponding to the magnetic field values in three dimensions.

The electronic device 200 can also include other sensors, in particular an inclinometer, a barometer, a temperature sensor and an altimeter to benefit from increased accuracy.

Furthermore, the electronic device 200 can include a data processing module 220 configured to transform the set of data generated using predefined algorithms. The processing module 220 makes it possible to analyze in 3D the posture, movements, locomotion, balance and environment of the user, and more generally everything that will be qualified as his gait, from the data collected by the inertial platform and any complementary sensors placed in the electronic device 200.

This processing module can be used to generate biomechanical parameters of the gait. Advantageously, the data processing module 220 is able to transform the set of data into at least one biomechanical parameter of the gait, said biomechanical parameter of the gait being preferably selected from: posture, pronation, supination, impact force, impact area, step length, contact time, air time, lameness, propulsive force, balance and several other parameters relating to the user and describing his gait, postures and movements.

The electronic device 200 further includes a data memory 240 configured to store at least part of the transformed data and/or the data generated by the data processing module 220.

Furthermore, the electronic device 200 includes a communication module 230. Thus, particularly, each of the electronic devices, whether master or slave, is designed so as to be able to communicate independently with the other casing and/or directly with an external terminal in order to be able to exchange its own information on the posture/movement/activity of the foot, from which it has received the data via the different sensors of the insole and/or outsole of the shoe.

Preferably, the communication module 230 is configured so that the electronic device 200 is able to transmit at least part of the transformed data to an external terminal 20. These data can be transmitted in real or delayed time to the external terminal 20. The external terminal 20 can be for example a remote system such as a tablet, a mobile telephone (Smartphone), a computer or a server.

The communication module 230 is able to receive and transmit data on at least one communication network. Preferably, the communication is carried out via a wireless protocol such as wifi, 3G, 4G, and/or Bluetooth. Preferably, the communication protocol is a BLE or ANT+ protocol. These communication protocols allow low energy consumption.

Furthermore, the electronic device 200 includes an energy source. The energy source is preferably a rechargeable battery 250. Furthermore, it can be associated with a recharging system by the movement or by external energy.

These different components of the electronic device 200 are preferably arranged on an electronic card 270 (or printed circuit). Furthermore, the different modules of the electronic device 200 are represented separately in [FIG. 3], but the invention can provide various types of arrangement as a single module combining all of the functions described here. Likewise, these modules can be divided into several electronic cards or brought together on a single electronic card.

Furthermore, the battery charging system 1 can include an external terminal 20 able to receive data. It may be able to transfer these data to a remote third-party server. It is then possible for example to access this remote server via a web interface.

Advantageously, a dedicated application is installed on the external terminal 20 in order to process the information transmitted by the electronic device 200 and allow the user to interact with said electronic device or more generally to indicate to the user the charge level of the rechargeable battery 250 of the electronic device 200.

Furthermore, one of the advantages of an electronic device of a battery charging system 1 according to the invention is that the electronic device 200 does not include any connection technology intended to receive an adapter making it possible to directly charge the battery. Indeed, the electronic devices of the prior art often comprise a wired connector connected to the battery, generally protected by a removable tab. The wired connector can be for example a USB or firewire port. The wired connection means is then used as mentioned above to recharge the battery, but also to exchange data and for example update the firmware of the electronic card carrying the different components of the electronic device.

As mentioned previously, a battery charging system 1 according to the invention includes a charging base 300 comprising a power supply configured to generate a charging current. The power supply can be integrated into the charging base, in this case the power supply can correspond to a battery coupled to the charging base. The power supply can also be remote, as is in particular the case for an external power supply coming from a power supply network and in this case, the charging base 300 includes a male electrical plug adapted to communicate with a female plug such as an embedded socket through which the charging current coming from the distribution network is distributed.

The charging base 300 further comprises a charging surface 310 intended to receive the shoe accessory 100. The charging surface 310 is advantageously formed by one or several connectors making it possible to establish an electrical connection between the power supply of the charging base 300 and the rechargeable battery 250 of the electronic device 100. For this, the charging base 300 is configured to send a charging current to the rechargeable battery 250 via the charging surface 310. The charging surface 310 is thus advantageously adapted to allow the establishment of electrical contact with the shoe accessory 100.

As mentioned previously, the cleat 100 can include at least one hooking system arranged to fit into the charging base 300 and allow a removable mechanical connection with said charging base 300. Advantageously, the hooking system is also arranged so that, once fitted into the charging base 300, the charging surface 310 comes into contact with the shoe accessory 100.

A battery charging system 1 according to the invention comprises conductive fixing means 140 intended to fix the shoe accessory 100 on a shoe 10-1, 10-2. The conductive fixing means 140 can correspond to any type of fixing making it possible to establish a reversible or non-reversible mechanical connection between the shoe accessory 100 and the shoe 10-1, 10-2. To allow such fixing, the shoe 10-1, 10-2 preferably comprises at least one accommodation means adapted to allow the formation of a reversible or non-reversible mechanical connection with a fixing means 140. The conductive fixing means 140 must allow conducting the charging current generated by the power supply of the charging base 300. Thus, the conductive fixing means 140 can be made entirely or partly of metal or of an alloy of several metals.

By way of non-limiting examples, the conductive fixing means 140 can be screws adapted to allow the fixing of the shoe accessory to the shoe 10-1, 10-2, more particularly to the outsole of the shoe 10-1, 10-2.

As mentioned previously in relation to [FIG. 2], the shoe accessory 100 can take the form of a cleat 100. In this embodiment, the cleat 100 can comprise at least one opening 116 allowing the passage of a screw and the cooperation with an accommodation means, for example a threaded hole arranged in the outsole of the shoe 10-1, 10-2, to form a connection between the shoe accessory 100 and the shoe 10-1, 10-2. As represented in [FIG. 2], the head of the screw can rest against a rim 115, formed in an electrically conductive material, formed around the opening 116 of the cleat body 110 in order to ensure such a connection. To ensure the holding by the screw, in particular between the head of the screw and the rim 115 of the cleat body 110, the conductive fixing means 140 can comprise a washer formed in an electrically conductive material.

In order to allow the charging of the rechargeable battery 250 of the electronic device 200, when the shoe accessory 100 is fixed to the shoe 10-1, 10-2, a first end of the conductive fixing means 140 comes into electrical contact with the rechargeable battery 250 and a second end of the conductive fixing means 140 comes into electrical contact with the charging surface 310 of the charging base 300.

Indeed, the conductive fixing means 140 advantageously allow the passage of the charging current generated by the power supply of the charging base 300 to the rechargeable battery 250.

In order to allow the passage of the charging current from the first end of the conductive fixing means 140 to the rechargeable battery 250, the electronic device 200 can comprise a connector.

The connector can consist of an electrical cable intended to be crimped or welded to the shoe accessory 100. The electrical cable must be crimped or welded to the shoe accessory 100 so that the first end of the conductive fixing means 140 enters into electrical contact with the rechargeable battery 250.

The connector can further consist of a spring connector. In this case, the shoe accessory 100 includes a housing, as mentioned previously, adapted to receive and hold the electronic device 200 so that the first end of the conductive fixing means 140 comes into electrical contact with the rechargeable battery 250 via the spring connector. Any type of spring connector known to those skilled in the art allowing the passage of the charging current from the conductive fixing means 140 to the electronic device 200 can be used. By way of non-limiting examples, the spring connector can be a finger spring type connector, soldered to the electronic card 270. The spring connector can also be a Pogo® type connector.

In all cases, the electronic device 200 is arranged to allow contact between the connector and the shoe accessory 100. For example, when the electronic device 200 comprises a casing or a shell, the casing or the shell can thus comprise an opening allowing the connector to come into contact with the shoe accessory 100 or with a conductive means.

To facilitate the passage of the charging current, the conductive fixing means 140, and more particularly the first end, can come into electrical contact with the rechargeable battery 250 through a conductive means 130. The conductive means 130 advantageously makes it possible to conduct the charging current of the first end of the conductive fixing means 140 to the connector.

The conductive means 130 can consist in whole or in part of the shoe accessory and is arranged to allow contact between the first end of the conductive fixing means 140 when the shoe accessory 100 is fixed to the shoe 10-1, 10-2. As a result, the conductive means 130 is preferably positioned in the vicinity of the first or the second end of the conductive fixing means 140 and the electronic device 200.

Alternatively, when the rim 115 is formed in an electrically conductive material, said rim 115 can perform the function of conductive means 130. As indicated in [FIG. 2], the rim 115 is formed around the opening 116 of the cleat body 110. The passage of the charging current can then occur via the part of the conductive fixing means 140 in contact with the conductive means 130.

Advantageously, to allow the passage of the charging current, the conductive means 130 can consist of a conductive coating, such as a conductive metal paint, said conductive coating being applied to the internal face of the shoe accessory 100, for example at the level of the rim 115. In this case, a groove can be made at the level of the internal face of the shoe accessory 100. Such a groove preferably extends from the rim 115 to the housing into which the electronic device 200 is inserted. The conductive coating can thus be applied in the groove and in the part of the housing in contact with the connector of the electronic device 200. The charging current can thus pass from the conductive fixing means 140 to the electronic device 200 via the conductive coating.

In the case where the conductive fixing means 140 consist of a screw and a washer, the passage of the charging current can also be done via the part of the conductive fixing means 140 in contact with the washer, when the latter is formed in an electrically conductive material, and when said washer is in contact with the conductive means 130. In this example, the washer comes into contact with the rim 115, acting as conductive means 130, when the shoe accessory 100 is fixed to the shoe 10-1, 10-2.

Alternatively, the passage of the charging current can occur directly via the first end of the conductive fixing means 140. Indeed, it is provided that the first end of the conductive fixing means 140 comes into contact with the conductive means 130. As detailed previously, the internal face of the shoe accessory 100 can be adapted to receive a conductive means 130 arranged so that the first end of the conductive fixing means 140 comes into electrical contact with the rechargeable battery 250 via the conductive means 130. In this example, the conductive means 130 is a lug washer, formed in an electrically conductive material. When the shoe accessory 100 is fixed to the shoe 10-1, 10-2, the lug of the washer comes into contact with the electronic device 200, more particularly with the connector, and with the first end of the conductive fixing means 140 thus allowing the passage of the charging current. By way of non-limiting example, the lug washer may have dimensions adapted to the conductive fixing means 140 and so that the edges of the lug washer rest on the periphery of the opening 116, represented by the rim 115 on [FIG. 2]. Furthermore, for the lug of the washer to come into electrical contact with the rechargeable battery 250, a hole (not represented in the figures) adapted to the lug of the washer can be provided in the shoe accessory 100. Although the lug washer was in a single element, it is provided that the lug washer and more generally the conductive means 130 can be composed of several distinct elements. For example, the lug can consist of a first distinct element and the washer can consist of a second distinct element forming the conductive means 130.

In order to facilitate the passage of the charging current from the conductive fixing means 140 to the rechargeable battery 250, the conductive means 130 can correspond to a track electrically connecting the first end of the conductive fixing means 140 to the rechargeable battery 250.

Thus, the electronic device 200 can be connected by the conductive means 130, taking the form of a track, via the connector of said electronic device 200. As non-limiting examples, the conductive means 130 can comprise a track to the connector of the electronic device 200.

Indeed, the connector of the electronic device 200 is electrically connected to the rechargeable battery 250, the charging current thus passes through the first end of the conductive fixing means 140 then through the conductive means 130, to the connector of said electronic device 200 in order to allow the charging of the rechargeable battery 250.

In one particular embodiment, in order to facilitate the passage of the charging current, the establishment of an electrical connection between the conductive fixing means 140 and the rechargeable battery 250 can be ensured by the establishment of a contact between the first end of the conductive fixing means 140 and the conductive means 130. Indeed, it is provided that, when fixing the shoe accessory 100 to the shoe 10-1, 10-2, the latter comprises an accommodation means, for example a threaded hole provided in the outsole of the shoe 10-1, 10-2, to form a connection between the shoe accessory 100 and the shoe 10-1, 10-2. In this case, the conductive fixing means 140 can take the form of a screw. The threaded hole can therefore comprise a conductive means 130 adapted to electrically connect the first end of the conductive fixing means 140, for example of the screw, to the rechargeable battery 250 and more particularly to the connector of the electronic device 200, when the shoe accessory 100 is fixed to the shoe 10-1, 10-2. In this embodiment, the conductive means 130 can, by way of non-limiting examples, be a track or an electric wire. The screw, acting as a conductive fixing means 140, can have a first end adapted to allow, when fixing the shoe accessory 100 to the shoe 10-1, 10-2, the passage of the charging current of the screw to the conductive means 130.

By way of non-limiting example, a battery charging system 1 according to the invention can comprise two conductive fixing means 140 respectively electrically connected to each pole of the rechargeable battery 250.

For example, when the conductive fixing means 140 are a screw, the first end can correspond to the body, to the tip and/or to the thread of the screw and the second end can correspond to the head of the screw, more particularly to the part of the screw comprising the footprint.

The user is then exempt from dismounting the shoe accessory 100 to access the rechargeable battery 250 and thus charge it.

In order to ensure the passage of the charging current continuously between the charging base 300, and more particularly from the charging surface 310 to the rechargeable battery 250, a hooking system according to the invention is preferably arranged to fit into the charging base 300 and to ensure the electrical contact between the second end of the conductive fixing means 140 and the charging surface 310. By way of non-limiting example, when the second end of the conductive fixing means 140 is a screw head, the screw head is then held in contact with the charging surface 310 when the shoe 10-1, 10-2 is fitted via the shoe accessory 100 to the charging base 300.

According to another aspect, the invention relates to a shoe 10-1, 10-2 comprising a shoe accessory 100 adapted to receive an electronic device 200 comprising a rechargeable battery 250, the shoe accessory 100 being fixed to the shoe via conductive fixing means 140, preferably metallic, including a first end and a second end.

As detailed previously in connection with the battery charging system 1, the shoe accessory 100 is adapted to be received by a charging surface 310 of a charging base 300, so that when the shoe accessory 100 is received by the charging surface 310:
the first end of the conductive fixing means 140 comes into electrical contact with the rechargeable battery 250, and
the second end of the conductive fixing means 140 comes into electrical contact with the charging surface 310.

Such a shoe 10-1, 10-2 can correspond to any type of shoe known to those skilled in the art, more particularly to any shoe requiring the use of a shoe accessory intended to allow their use for the practice of a sports activity in particular. Advantageously, but without limitation, the shoe 10-1, 10-2 can be a cycling shoe.

In order to ensure the mounting of the shoe accessory 100, a shoe according to the invention can comprise an outsole including at least one accommodation means and in which the shoe accessory 100 comprises at least one opening 116. The conductive fixing means 140 are then adapted to cooperate with the accommodation means through the opening 116 so as to form a mechanical connection between the shoe accessory 100 and the outsole of the shoe 10-1, 10-2.

Although the shoe accessory 100 has been described in connection with the outsole of a shoe, it is provided that the shoe accessory can be fixed to any other part of the shoe.

According to a third aspect, the invention relates to a charging base 300 comprising a power supply configured to generate a charging current and a charging surface 310 intended to receive a shoe accessory 100 of a shoe 10-1, 10-2 according to the invention, in which when the shoe accessory 100 of the shoe 10-1, 10-2 is received by the charging surface 310, the first end of the conductive fixing means 140 comes into electrical contact with the rechargeable battery 250, and the second end of the conductive fixing means 140 comes into electrical contact with the charging surface 310.

The charging base 300 is configured to send the charging current to the rechargeable battery 250 via the charging surface 310.

The charging base can advantageously be formed in a clipless pedal of an electric bike. Indeed, as described previously, the shoe accessory 100 can take the form of a cleat fixed to a shoe, therefore in this case a cycling shoe. In this embodiment, the cleat 100 can comprise any type of known hooking system allowing the cleat to be fixed to the clipless pedal. Complementarily, the clipless pedal can comprise a fixing adapted to the cleat hooking system.

The power supply could then consist of a battery integrated into said electric bike. The battery can thus be electrically coupled to the clipless pedal, for example via the crankset, in order to generate a charging current making it possible to power the rechargeable battery 250 of the electronic device 200 when a shoe 10-1, 10-2 according to the invention is received by the charging surface 310 of the clipless pedal.

1. A battery charging system comprising:
a shoe accessory adapted to receive an electronic device comprising a rechargeable battery,
a charging base comprising a power supply configured to generate a charging current, and a charging surface configured to receive the shoe accessory, the charging base being configured to send the charging current to the rechargeable battery via the charging surface, and
conductive fixing means configured to fix the shoe accessory on a shoe,
wherein, when the shoe accessory is fixed to a shoe;
a first end of the conductive fixing means comes into electrical contact with the rechargeable battery, and
a second end of the conductive fixing means comes into electrical contact with the charging surface.

2. The charging system according to claim 1, wherein the electronic device comprises a connector comprising an electrical cable configured to be crimped or welded to the shoe accessory so that the first end of the conductive fixing means comes into electrical contact with the rechargeable battery.

3. The charging system according to claim 1, wherein the shoe accessory includes a housing and the electronic device comprises a spring connector, said housing being adapted to receive and hold the electronic device so that the first end of the conductive fixing means comes into electrical contact with the rechargeable battery via the spring connector.

4. The charging system according to claim 1, wherein the shoe accessory comprises an internal face adapted to receive a conductive means, said conductive means being arranged so that the first end of the conductive fixing means comes into electrical contact with the rechargeable battery via the conductive means.

5. The charging system according to claim 4, wherein the conductive means is a lug washer.

6. The charging system according to claim 1, wherein the shoe accessory comprises at least one hooking system arranged to fit into the charging base and to ensure the electrical contact between the second end of the conductive fixing means and the charging surface.

7. A shoe comprising a shoe accessory adapted to receive an electronic device comprising a rechargeable battery, the shoe accessory being fixed to the shoe via conductive fixing means including a first end and a second end, the shoe accessory being further adapted to be received by a charging surface of a charging base, so that when said shoe accessory is received by the charging surface:
the first end of the conductive fixing means comes into electrical contact with the rechargeable battery, and
the second end of the conductive fixing means comes into electrical contact with the charging surface.

8. The shoe according to claim 7, further comprising an outsole which comprises at least one accommodation means and wherein the shoe accessory comprises an opening, the conductive fixing means being adapted to cooperate with the accommodation means through the opening so as to form a mechanical connection between the shoe accessory and the outsole of the shoe.

9. The shoe according to claim 7, wherein the electronic device comprises a connector comprising an electrical cable configured to be crimped or welded to the shoe accessory so that the first end of the conductive fixing means comes into electrical contact with the rechargeable battery.

10. The shoe according to claim 7, wherein the shoe accessory includes a housing and the electronic device comprises a spring connector, said housing being adapted to receive and hold the electronic device such that the first end of the conductive fixing means comes into electrical contact with the rechargeable battery via the spring connector.

11. The shoe according to claim 7, wherein the shoe accessory comprises at least one hooking system arranged to fit into the charging base and to ensure the electrical contact between the second end of the conductive fixing means and the charging surface.

12. A charging base comprising a power supply configured to generate a charging current and a charging surface configured to receive the shoe accessory of the shoe according to claim 7, wherein when the shoe accessory of the shoe is received by the charging surface, the first end of the conductive fixing means comes into electrical contact with the rechargeable battery, and the second end of the conductive fixing means comes into electrical contact with the charging surface, the charging base being further configured to send the charging current to the rechargeable battery via the charging surface.

13. The charging base according to claim 12, wherein the charging base is formed in a clipless pedal of an electric bike and the power supply is a battery integrated into said electric bike, said battery being electrically coupled to the clipless pedal.
